(19) United States
(12) Patent Application Publication
(10) Pub. No.: US 2016/0375938 A1
(43) Pub. Date: Dec. 29, 2016

(54) SUSPENSION MEMBER

(71) Applicant: Toyota Jidosha Kabushiki Kaisha, Toyota-shi (JP)

(72) Inventors: Yasuhide MATSUO, Toyota-shi (JP); Soshiro MURATA, Toyota-shi (JP)

(73) Assignee: Toyota Jidosha Kabushiki Kaisha, Toyota-shi (JP)

(21) Appl. No.: 15/081,053

(22) Filed: Mar. 25, 2016

(30) Foreign Application Priority Data
Jun. 26, 2015 (JP) 2015-129090

(51) Int. Cl. B62D 21/15

(52) U.S. Cl. CPC B62D 21/152

(57) ABSTRACT

The suspension member includes: a rear cross member that extends along the vehicle width direction, and that includes a left and right pair of sub side rails that integrally extend from respective vehicle width direction end portions of the rear cross member toward the vehicle body front side; and a left and right pair of side rails that extend along the extension direction of the sub side rails, that each include a bent portion protruding toward the vehicle body lower side at an extension direction intermediate portion of the side rail, wherein the upper side of an end portion further toward a vehicle body rear side than the bent portion is covered by, and joined to, the respective sub side rail, and the lower side of the end portion further toward the vehicle body rear side than the bent portion is in an exposed state.

### CROSS-REFERENCE TO RELATED APPLICATION

This application claims priority under 35 USC 119 from Japanese Patent Application No. 2015-129090, filed on Jun. 26, 2015, the disclosure of which is incorporated by reference herein.

### BACKGROUND

Technical Field

The present disclosure relates to a suspension member of a vehicle. Related Art

Conventionally, suspension members in which left and right rear connecting portions and a rear portion lateral member are integrally formed by die-casting, left and right front connecting portions are formed by die-casting, and a front portion lateral member and left and right longitudinal members are extrusion formed (see, for example, Japanese Patent Application Laid-Open (JP-A) No, 2005-289131) are known.

However, there is still room for improvement in a structure to efficiently absorb load during a head-on collision of the vehicle or the like, by deforming left and right longitudinal members (side frames) of a suspension member so as to be bent in a downward protruding shape due to load input from the vehicle body front side.

### SUMMARY

The present invention provides a suspension member that may efficiently absorb load input from a vehicle body front side.

A suspension member of a first aspect includes: a front cross member that is formed with a closed cross-section profile by extrusion forming a light metal, and that extends along a vehicle width direction; a left and right pair of front body mounts that are each formed with an open cross-section profile open toward a vehicle body lower side by die-casting a light metal, and that are respectively joined to respective vehicle width direction end portions of the front cross member; a rear cross member that is formed with an open cross-section profile open toward the vehicle body lower side by die-casting a light metal, that extends along the vehicle width direction, and that includes a left and right pair of sub side rails that integrally extend from respective vehicle width direction end portions of the rear cross member toward a vehicle body front side; and a left and right pair of side rails that are formed with a closed cross-section profile by extrusion forming a light metal, that extend along an extension direction of the sub side rails, and that each include a bent portion protruding toward the vehicle body lower side at an extension direction intermediate portion of the side rail, wherein an end portion further toward the vehicle body front side than the bent portion is joined to the front body mount, an upper side of an end portion further toward a vehicle body rear side than the bent portion is covered by, and joined to, the sub side rail, and a lower side of the end portion further toward the vehicle body rear side than the bent portion is in an exposed state.

In the first aspect, in a case in which load has been input to the suspension member from the vehicle body front side in a head-on collision of the vehicle or the like, each side rail, formed with a closed cross-section profile by extrusion forming a light metal, deforms so as to be bent in a downward protruding shape from the bent portion, such that the vehicle body front side end portion thereof faces toward the vehicle body upper rear side. Note that the upper side of the end portion further toward the vehicle body rear side than the bent portion of each side rail is covered by, and joined to, the respective sub side rail that is formed with an open cross-section profile open toward the vehicle body lower side by die-casting a light metal. The lower side of the end portion further toward the vehicle body rear side than the bent portion of each side rail is in an exposed state.

Thus, in the first aspect, due to the difference in strength between the side rail and the sub side rail, the bent portion of the side rail more readily deforms so as to be bent in a downward protruding shape, and there is no concern of the bending deformation (tensile deformation at a lower face side) at the bent portion of the side rail being impeded by the sub side rail. Accordingly, the load may be efficiently absorbed by the suspension member.

A second aspect, in the above first aspect, a lower end portion of the sub side rail may be welded to an imaginary intersecting-line portion, which is an intersecting portion of a neutral plane of the side rail, in a case in which the side rail is deformed so as to be bent from the bent portion, and the wall portion of the side rail.

In the second aspect, the lower end portion of each sub side rail is welded to the imaginary intersecting-line portion of the wall portion of the side rail, wherein the imaginary intersecting-line portion is a portion at which the neutral plane of the side rail intersects with the wall portion of the side rail. Note that the imaginary intersecting-line portion of the wall portion of the side rail to which with the neutral plane of the side rail intersects with, is a location where bending stress is least liable to act in a case in which the side rail is deformed so as to be bent from the bent portion. Thus, in the second aspect, in a case in which the side rail is deformed so as to be bent from the bent portion, the bending stress acting on the welded location may be suppressed to a minimum, and may enable the side rail to be suppressed from coming away from the sub side rail.

A third aspect, in the above aspects, an upper side of the end portion of the side rail further toward the vehicle body front side than the bent portion may be covered by, and joined to, the front body mount, and a lower side of the end portion of the side rail further toward the vehicle body front side than the bent portion may be in an exposed state.

In the third aspect, the upper side of the end portion of each side rail further toward the vehicle body front side than the bent portion is covered by, and joined to, the respective front body mount that is formed with an open cross-section profile open toward the vehicle body lower side by die-casting a light metal. The lower side of the end portion of the side rail further toward the vehicle body front side than the bent portion is in an exposed state.

Thus, in the third aspect, due to the difference in strength between the side rail and the front body mount, the bent portion of the side rail more readily deforms bending in a downward protruding shape, and the bending deformation (tensile deformation at a lower face side) at the bent portion of the side rail may not be impeded by the front body mount. Thus, in the third aspect, the load may be even more efficiently absorbed by the suspension member.

A fourth aspect, in the above third aspect, a lower end portion of the front body mount may be welded to an imaginary intersecting-line portion, which is an intersecting portion of a neutral plane of the side rail, in a case in which the side rail is deformed so as to be bent from the bent portion, and the wall portion of the side rail.

In the fourth aspect, the lower end portion of the front body mount is welded at the imaginary intersecting-line portion of the wall portion of the side rail, wherein the imaginary intersecting-line portion is a portion at which the neutral plane of the side rail intersects with the wall portion of the side rail. Note that the imaginary intersecting-line portion of the wall portion of the side rail to which the neutral plane of the side rail intersects with, is a location where bending stress is least liable to act in a case in which the side rail is deformed so as to be bent from the bent portion. Thus, in the fourth aspect, in a case in which the side rail is deformed so as to be bent from the bent portion, the bending stress acting on the welded location is suppressed to a minimum, and may enable the side rail to be suppressed from coming away from the front body mount.

A fifth aspect, in the above aspects, the sub side rail may be formed with a hat-shaped cross-section profile.

In the fifth aspect, each sub side rail is formed with a hat-shaped cross-section profile. Namely, ribs that respectively project out toward the vehicle width direction outside and the vehicle width direction inside are integrally formed to lower end portions of the sub side rail. Thus, in the fifth aspect, the strength (rigidity) of the sub side rail is improved, and the difference in strength between the sub side rail and the side rail is increased, compared to configurations in which the sub side rail is not formed with a hat-shaped cross-section profile. Thus, in the fifth aspect, the side rail more readily deforms bending from the bent portion.

A sixth aspect, in the above aspects, the bent portion may be formed at an extension direction center portion of the sub side rail.

In the sixth aspect, the bent portion is formed to the extension direction center portion of each sub side rail. Thus, load concentrates more readily at the bent portion than in configurations in which the bent portion is not formed at the extension direction center portion of the side rail. Thus, in the sixth aspect, bending deformation from the bent portion of the side rail may be promoted.

Note that in the present invention, “center portion” includes not only the exact center portion, but also substantially center portions that are slightly offset from the exact center portion. Moreover, in the present invention, “imaginary intersecting-line portion” includes not only a portion exactly on the imaginary intersecting-line, but also a portion substantially on the imaginary intersecting-line, slightly offset from the exact imaginary intersecting-line.

The first aspect may enable load input from the vehicle body front side to be efficiently absorbed by the suspension member.

The second aspect may enable the side rail to be suppressed from coming away from the sub side rail when load has been input to the suspension member from the vehicle body front side.

The third aspect may enable load input from the vehicle body front side to be even more efficiently absorbed by the suspension member.

The fourth aspect may enable the side rail to be suppressed from coming away from the front body mount when load has been input to the suspension member from the vehicle body front side.

The fifth aspect may enable the side rail to be readily deformed bending from the bend portion, in a case in which load has been input to the suspension member from the vehicle body front side.

The sixth aspect may enable bending deformation from the bend portion of the side rail to be promoted when load has been input to the suspension member from the vehicle body front side.

### BRIEF DESCRIPTION OF THE DRAWINGS

Exemplary embodiments will be described in detail based on the following figures, wherein:

FIG. 1 is a perspective view viewed from above, illustrating a suspension member according to an exemplary embodiment;

FIG. 2 is a perspective view viewed from below, illustrating a suspension member according to an exemplary embodiment;

FIG. 3 is a cross-section viewed along arrow line X-X in FIG. 1;

FIG. 4 is a side view illustrating a state prior to a head-on collision of a suspension member according to the present exemplary embodiment;

FIG. 5 is a side view illustrating a state after a head-on collision of a suspension member according to the present exemplary embodiment; and

FIG. 6 is a partially exploded perspective view viewed from above, illustrating a suspension member according to a reference example.

### DETAILED DESCRIPTION

Detailed explanation follow regarding an exemplary embodiment according to the present invention, based on the drawings. Note that for ease of explanation, in each of the drawings, the arrow UP indicates the vehicle body upper direction, the arrow FR indicates the vehicle body front direction, and the arrow RH indicates the vehicle body right direction, as appropriate. In the below explanation, unless specifically stated otherwise, reference to the up-down, front-rear, and left-right directions refers to up-down in the vehicle body up-down direction, front-rear in the vehicle body front-rear direction, and left-right in the vehicle body left-right direction (vehicle width direction).

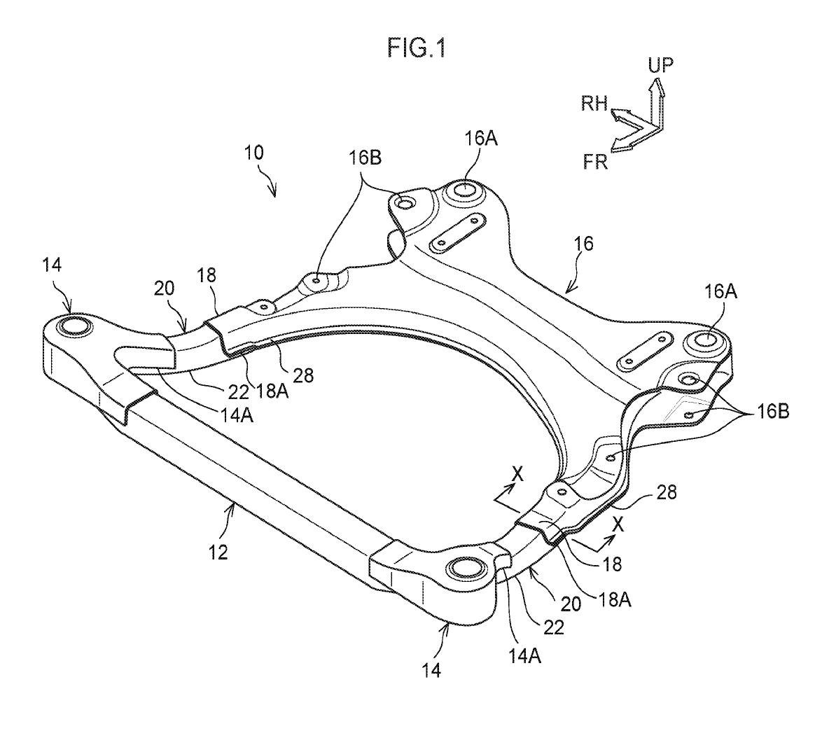

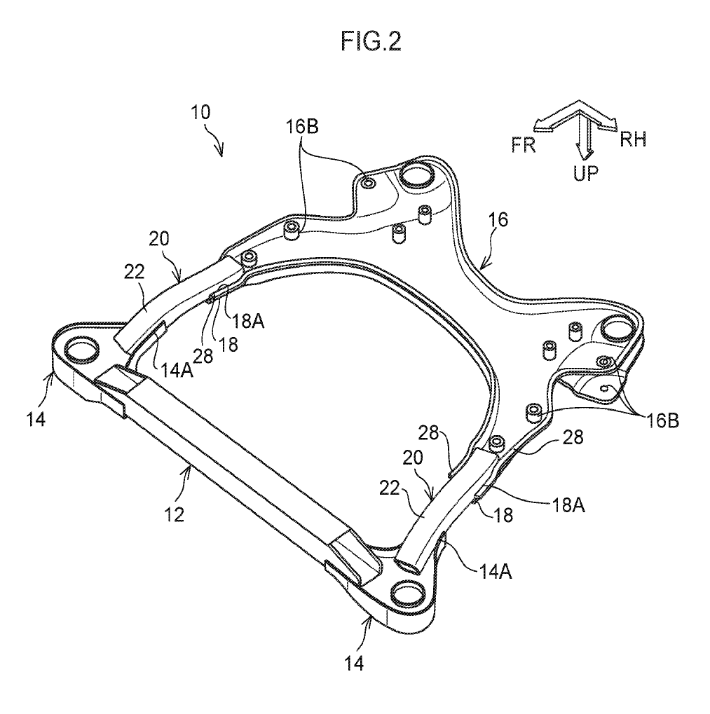

A suspension member 10 illustrated in FIG. 1 and FIG. 2 is supported by front portion lower sides of a left and right pair of front side members (not illustrated in the drawings) extending along the vehicle body front-rear direction, in a state suspended from the front side members. Each front side member includes a kick portion, such that a vehicle body front portion side is positioned higher than a vehicle body rear portion side.

Thus, a left and right pair of front body mounts 14, described later, these being a front end portion of the suspension member 10, are attached to front end portions of the front side members further toward the vehicle body front side than the kick portions. A left and right pair of fastening portions 16A of a rear cross member 16, described later, this being a rear end portion of the suspension member 10, are attached to lower end portions of the kick portions.

The suspension member 10 includes a front cross member 12 extending along the vehicle width direction, the left and right pair of front body mounts 14 joined to respective vehicle width direction end portions of the front cross member 12, and the rear cross member 16 that extends along the vehicle width direction and that includes a left and right pair of sub side rails 18 that extend integrally from respective vehicle width direction end portions toward the respective vehicle body front direction outsides. Further, the suspension member 10 includes a left and right pair of side rails 20 which extend along the extension direction of the sub side rails 18, that have vehicle body front side end portions joined to the respective front body mounts 14, and that have vehicle body rear side end portions joined to the respective sub side rails 18.

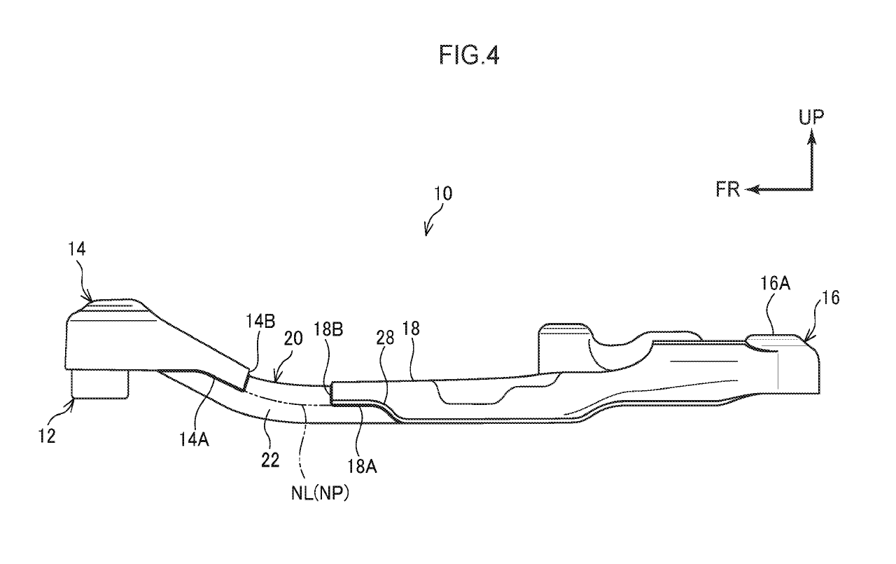

As illustrated in FIG. 1 to FIG. 4, the front cross member 12 and the side rails 20 are each formed with a uniform, rectangular shaped closed cross-section profile by extrusion forming a light metal material such as an aluminum alloy, and have high ductility. A substantially length direction (extension direction) center portion of each side rail 20 includes a (downward protruding shaped) bent portion 22 that protrudes toward the vehicle body lower side in side view viewed from the vehicle width direction (see FIG. 4).

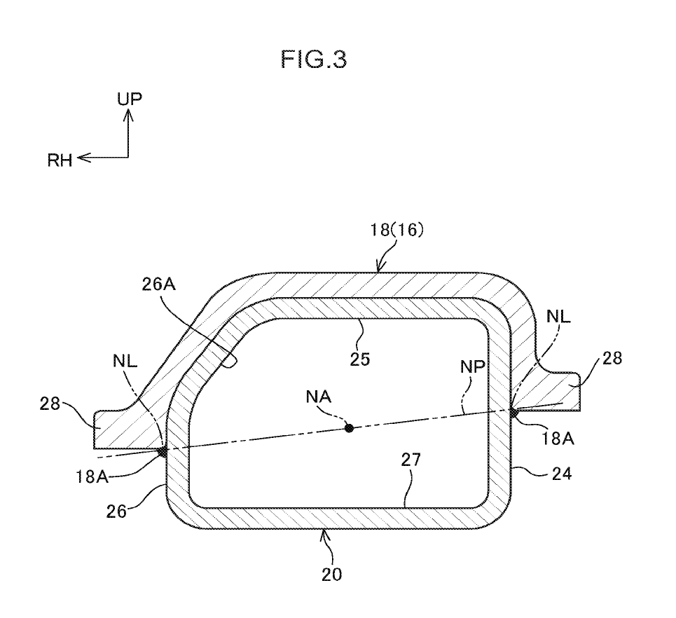

Each front body mount 14 is formed with an open cross-section profile open toward the vehicle body lower side by die-casting a light metal material such as an aluminum alloy, and is configured supported by the front end portion of the respective front side member. The rear cross member 16 is formed with an open cross-section profile open toward the vehicle body lower side by die-casting a light metal material such as an aluminum alloy, and each sub side rail 18 is also formed with an open cross-section profile open toward the vehicle body lower side (an inverted, substantially “U shaped” cross-section) (see FIG. 3).

Substantially an upper half (upper side) of an end portion of each side rail 20 further toward the vehicle body rear side than the respective bent portion 22 is covered by the respective sub side rail 18, and joined thereto by arc welding lines. Substantially a lower half (lower side) of the end portion of each side rail 20 further toward the vehicle body rear side than the respective bent portion 22 is not covered by the respective sub side rail 18 or the like, and remains in a state exposed to the exterior (see FIG. 2).

Substantially an upper half (upper side) of an end portion of each side rail 20 further toward the vehicle body front side than the respective bent portion 22 is covered by the respective front body mount 14, and joined thereto by arc welding lines. Substantially a lower half (lower side) of the end portion of each side rail 20 further toward the vehicle body front side than the respective bent portion 22 is not covered by the respective front body mount 14 or the like, and remains in a state exposed to the exterior (see FIG. 2).

Note that more detailed explanation follows regarding the joint structures of the sub side rails 18 and the front body mounts 14 to the side rails 20.

A line shaped (running along the length direction of the side rail 20) region, where respective bend stresses (tensile deformation force and compression deformation force) are least liable to act when the front end portion of the side rail 20 has deformed so as to be bent from the bent portion 22 toward the vehicle body upper side, is present at a vehicle body up-down direction intermediate portion of an outer wall (wall portion) 24 and of an inner wall (wall portion) 26. The outer wall (wall portion) 24 is a side wall facing the vehicle width direction outside of the side rail 20. The inner wall (wall portion) 26 is a side wall facing the vehicle width direction inside of the side rail 20.

As illustrated in FIG. 3 to FIG. 5, when the side rail 20 has deformed so as to be bent in a downward protruding shape from the bent portion 22, tensile deformation force at a lower wall 27 side (lower face side), and compression deformation force at an upper wall 25 side (upper face side), of the side rail 20 are both less liable to act at these line shaped regions. Moreover, the line shaped regions are imaginary intersecting-line portions (hereafter referred to as “intersecting-line portions NL”) between a neutral plane NP, this being an imaginary plane passing through a neutral axis NA running along the length direction of the side rail 20 (forming the center of tensile force and compression force), and the outer wall 24 and inner wall 26 of the side rail 20.

Lower end portions 18A of side walls of the sub side rail 18 and lower end portions 14A of side walls of the front body mount 14 are respectively joined thereto by arc welding lines at the intersecting-line portions NL. Note that the “intersecting-line portions NL” according to the present exemplary embodiment not only includes portions exactly on the imaginary intersecting-lines, but also portions on imaginary substantially intersecting lines that are slightly offset from the exact imaginary intersecting-lines.

Although not illustrated in the drawings, in side view viewed from the vehicle width direction, a rear end upper portion of the side rail 20 covered by the sub side rail 18 is cut away at an incline toward the vehicle body lower rear side. Thus the neutral plane NP of the side rail 20 is sloped toward the vehicle body lower rear side on progression toward a rear end portion thereof

As illustrated in FIG. 4, the lower end portions 18A (arc welded portions) of the sub side rails 18, which are arc welded to the outer wall 24 and the inner wall 26 of the side rail 20, are thereby sloped toward the vehicle body lower rear side on progression toward the rear end portion of the side rail 20. Note that similar applies to a front end upper portion of the side rail 20, which is covered by the front body mount 14, and to the lower end portions 14A (arc welded portions) of the front body mounts 14.

Overlap amounts between the side rail 20, and the sub side rail 18 and the front body mount 14, namely, the lengths of the arc welded portions along the length direction of the side rail 20, are pre-set to a suitable amount. A front end portion 18B of the sub side rail 18 and a rear end portion 14B of the front body mount 14 are also line-joined by arc welding to the outer wall 24, the upper wall 25, and the inner wall 26 of the side rail 20.

As illustrated in FIG. 3, in face-on cross-section view viewed from the vehicle body front-rear direction, an upper portion of the inner wall 26 of the side rail 20 configures a sloped wall 26A that slopes upward toward the vehicle width direction outside (downward toward the vehicle width direction inside), in order to avoid impinging on (contacting) a power unit or the like, described later.

Note that the sub side rail 18 extends outward toward the vehicle front side, and the side rail 20 is disposed on this extension line. Thus, when load is input from the vehicle body front side and a front end portion of the side rail 20 deforms so as to be bent from the bent portion 22, compression deformation force is applied not only to the upper wall 25 of the side rail 20, but also to the upper portion of the inner wall 26.

However, since the sloped wall 26A is formed to the upper portion of the inner wall 26 of the side rail 20, resistant force against compression deformation force at the upper wall 25 side (upper face side) is less liable to occur. Configuration is thereby such that, even in a case in which the side rail 20 extends outward toward the vehicle body front side, bending deformation from the bent portion 22 is facilitated.

The lower end portion 18A at the vehicle width direction inside side wall (at the inner wall 26 side of the side rail 20) of the sub side rail 18 extends toward the vehicle body lower side to a position past the sloped wall 26A of the side rail 20. Configuration is thereby made such that the vehicle body rear side end portion, where compression deformation of the sloped wall 26A is undesirable, is reinforced. Note that configuration is made such that the intersecting-line portion NL of the inner wall 26 of the side rail 20 is not present on the sloped wall 26A.

Namely, the side rail 20 has a cross-section profile in which the sloped wall 26A is only formed to the upper portion of the inner wall 26, and an upper portion of the outer wall 24 is not formed with a sloped wall (the cross-section profile is not a profile with left-right symmetry). Thus, in face-on view viewed from the vehicle body front-rear direction, the neutral plane NP is inclined slightly upward toward the vehicle width direction outside (downward toward the vehicle width direction inside) with respect to the horizontal direction (see FIG. 3).

Each sub side rail 18 is formed with a substantially hat-shaped cross-section profile that has a thicker plate thickness than the side rail 20. Namely, ribs 28, which respectively project out toward the vehicle width direction outside and the vehicle width direction inside, are integrally formed to the lower end portions 18A of the sub side rail 18. Configuration is thereby made such that the strength and rigidity of the sub side rail 18 is further improved.

The power unit (not illustrated in the drawings), including an engine and a transmission, is installed at the vehicle body front side of the suspension member 10. An engine mount (not illustrated in the drawings) is accordingly provided at substantially a vehicle width direction center portion of the front cross member 12 of the suspension member 10, in order to support the power unit from the lower side.

Note that, as illustrated in FIG. 1 and FIG. 2, substantially an upper half of the respective vehicle width direction end portion of the front cross member 12 is covered by the respective front body mount 14 and line-joined thereto by arc welding. Substantially a lower half of the respective vehicle width direction end portion of the front cross member 12 is not covered by the respective front body mount 14 or the like, and remains in a state exposed to the exterior.

The respective vehicle width direction end portion of the front cross member 12 is cut away at an incline upward toward the vehicle width direction outside (downward toward the vehicle width direction inside). Namely, configuration is made such that there is no sudden change occurring in the cross-section profile at the respective vehicle width direction end portion of the front cross member 12. Configuration is thereby made such that a reduction in strength at the respective vehicle width direction end portion of the front cross member 12 is suppressed or prevented.

As illustrated in FIG. 1, the respective vehicle width direction end portion of the rear cross member 16 is formed with the fastening portion 16A for attachment to the lower end portion of the kick portion of the respective front side member. As illustrated in FIG. 1 and FIG. 2, the respective vehicle width direction end portion of the rear cross member 16 is also formed with lower arm attachment portions 16B for attachment to a lower arm (not illustrated in the drawings) configuring a suspension (not illustrated in the drawings).

Explanation follows regarding operation of the suspension member 10 configured as described above.

As described above, the engine mount that supports the power unit from the lower side is provided at substantially the vehicle width direction center portion of the front cross member 12. Thus, in a head-on collision of the vehicle, a portion of the collision load is input to the front cross member 12 of the suspension member 10 through the power unit.

Note that the rear cross member 16 including the sub side rails 18 is formed by die-casting, and its strength and rigidity are secured. In particular, the plate thickness of each sub side rail 18 is formed thicker than the plate thickness of the side rails 20, and ribs 28, which respectively project out toward the vehicle width direction outside and the vehicle width direction inside, are integrally formed to the lower end portions 18A of each sub side rail 18 (formed with a hat-shaped cross-section profile), such that its strength and rigidity is improved.

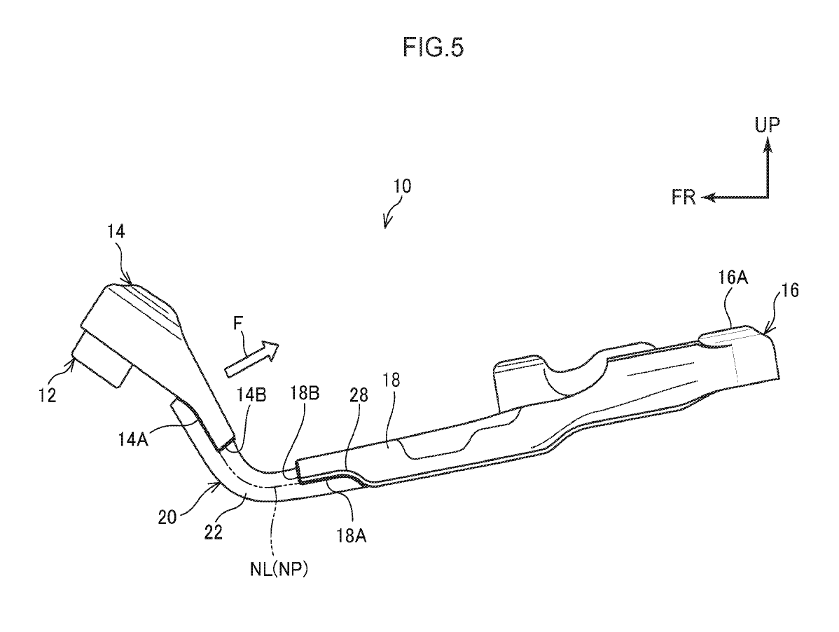

Thus, when the portion of the collision load is input to the front cross member 12 from the vehicle body front side, as illustrated in FIG. 5, due to a difference in durability (difference in strength) between the sub side rails 18 and the side rails 20, the front end portions of the side rails 20 deforms to be bent from the bent portions 22 toward the vehicle body upper rear side (in the arrow F direction), and deformation of front end portions of the sub side rails 18 toward the vehicle body upper rear side is suppressed or prevented.

In a case in which this occurs, substantially the lower half of the end portion further toward the vehicle body rear side than the bent portion 22 of each side rail 20 is not covered by the sub side rail 18, and remains in the state exposed to the exterior. Thus there is no concern of the bending deformation (energy absorption by plastic deformation) from the bent portion 22 of the side rail 20 being impeded by the sub side rail 18.

To explain in detail, for example, although not illustrated in the drawings, if the configuration was such that each sub side rail had a closed cross-section profile, and the vehicle body rear side end portion of the side rail 20 was inserted into the sub side rail and joined (welded) thereto, substantially the lower half of the vehicle body rear side end portion of the side rail 20 would be covered by the sub side rail. There would accordingly be a concern that plastic deformation of the tensile deformation side (lower face side) of the side rail 20 would be impeded by the sub side rail.

However, in the suspension member 10 according to the present exemplary embodiment, configuration is made such that substantially the lower half of the vehicle body rear side end portion of the side rail 20 is not covered by a covering member such as the sub side rail, such that there is no concern of plastic deformation of the tensile deformation side (lower face side) of the side rail 20 being impeded.

The upper portion of the inner wall 26 of the side rail 20 configures the sloped wall 26A, such that, even though the sub side rail 18 and the side rail 20 extend outward toward the vehicle body front side, there is no concern of plastic deformation of the compression deformation side (upper face side) of the side rail 20 being impeded. This enables the side rail 20 to readily deform bending from the bent portion 22.

Thus, the energy of the portion of the collision load input to the front cross member 12 of the suspension member 10 through the power unit is efficiently absorbed by bending deformation (plastic deformation) from the bent portions 22 of the side rails 20 of the suspension member 10.

In particular, the bent portion 22 is formed at substantially the length direction center portion of each side rail 20, such that load is readily concentrated at the bent portion 22. This enables bending deformation from the bent portion 22 of the side rail 20 to be promoted (to be well controlled), and enables the energy absorption properties to be improved.

Note that substantially the lower half of the end portion further toward the vehicle body front side than the bent portion 22 of the side rail 20 is not covered by the front body mount 14, and remains in a state exposed to the exterior. There is accordingly no concern of the bending deformation (energy absorption by plastic deformation) from the bent portion 22 of the side rail 20 being impeded by the front body mount 14.

Namely, since there is no concern of plastic deformation at the tensile deformation side (lower face side) of the side rail 20 being impeded by the front body mount 14, the side rail 20 can be deformed so as to be bent from the bent portion 22 even more readily. Thus the portion of collision load energy input to the front cross member 12 is even more efficiently absorbed by the side rail 20.

The lower end portions 18A of the sub side rail 18 are line-joined by arc welding to the intersecting-line portions NL of the outer wall 24 and the inner wall 26 of each side rail 20, such that, even in a case in which the side rail 20 has deformed so as to be bent from the bent portion 22, bending stress is less liable to act on the arc welded portions (bending stress is suppressed to a minimum at the arc welded portions). The side rail 20 is thereby suppressed or prevented from coming away from the sub side rail 18 (the arc welded portions are suppressed or prevented from fracturing), and there is no concern of energy absorption properties by the side rail 20 being reduced.

Similarly, the lower end portions 14A of the front body mount 14 are line-joined by arc welding to the intersecting-line portions NL of the outer wall 24 and the inner wall 26 of each side rail 20, such that, even in a case in which the side rail 20 has deformed so as to be bent from the bent portion 22, bending stress is less liable to act on the arc welded portions (bending stress is suppressed to a minimum at the arc welded portions). The side rail 20 is thereby suppressed or prevented from coming away from the front body mount 14 (the arc welded portions are suppressed or prevented from fracturing), and there is no concern of energy absorption properties by the side rail 20 being reduced.

Moreover since the front body mounts 14 and the rear cross member 16 are formed by die-casting a light metal material such as an aluminum alloy, a seating face or a boss can be easily formed in order to attach other attachment components. Namely, the front body mounts 14 and the rear cross member 16 have high degrees of freedom with respect to their shape while having a high rigidity, enabling a reduction in the number of components (a rationalized shape) to be realized.

The front body mounts 14 and the rear cross member 16 are each formed with an open cross-section profile open toward the vehicle body lower side, such that assembly (joining) to the front cross member 12 and to the side rails 20 is easy. This enables the assembly process of the suspension member 10 to be made simpler.

The front cross member 12 and the side rails 20 are formed by extrusion forming a light metal material such as an aluminum alloy. Thus, similarly to the front body mounts 14 and the rear cross member 16, there are high degrees of freedom with respect to their shape, and there is no need to cover substantially the lower halves of the respective end portions with a covering member or the like, such that a reduction in the number of components is realized. This enables the weight of the suspension member 10 formed of a light metal material to be further reduced.

The side rail 20 and the respective sub side rail 18 are line-joined together by arc welding, thereby enabling both members to be firmly joined together, and enabling foreign matter to be suppressed or prevented from entering between the members. This enables the occurrence of electrolytic corrosion between the members to be suppressed or prevented. Note that similar applies to the line-joining of the side rail 20 and the respective front body mount 14 by arc welding.

Configuration is made such that the lower arm is only attached to the respective rear cross member 16, thereby enabling the supporting rigidity of the suspension member 10 with respect to the lower arm to be improved. This enables noise caused by vibrations input from front wheels (not illustrated in the drawings) and the power unit to be suppressed.

Explanation follows regarding a suspension member 11 according to a reference example. Note that similar locations to the suspension member 10 according to the present exemplary embodiment are appended with the same reference numerals, and detailed explanation thereof (including common operation) is omitted as appropriate.

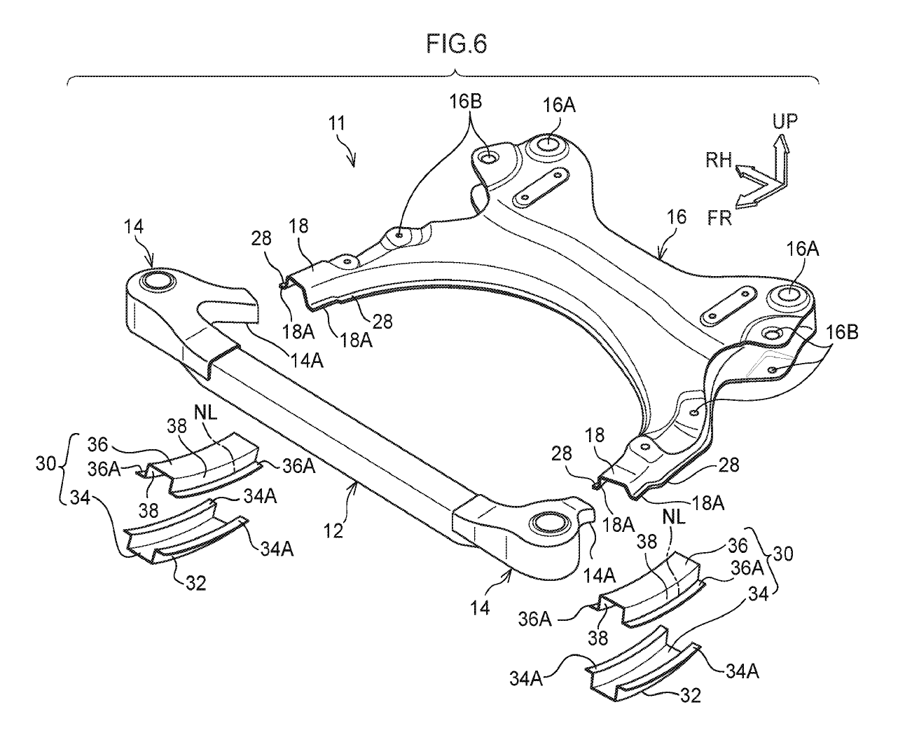

As illustrated in FIG. 6, the suspension member 11 according to the reference example differs from the suspension member 10 according to the present exemplary embodiment in the respect that each side rail 30 is configured by an upper panel 36 with a substantially hat-shaped cross-section profile, and a lower panel 34 with a substantially hat-shaped cross-section profile.

Namely, the side rail 30 is formed with a rectangular shaped, closed cross-section profile by joining flange portions 36A of the upper panel 36 to respective flange portions 34A of the lower panel 34 by spot welding or the like. The lower end portions 18A at the side walls of the sub side rail 18 and the lower end portions 14A at the side walls of the front body mount 14 are respectively line-joined by arc welding to the intersecting-line portions NL (further toward the upper side than the flange portions 36A) at the respective side walls 38 of the side rail 30 (upper panel 36).

A downward protruding shaped bent portion 32 is formed at substantially a length direction center portion of each side rail 30. Thus, during a head-on collision of the vehicle, the suspension member 11 according to the reference example also deforms so as to be bent (plastic deformation) from the bent portion 32, such that a front end portion of the side rail 30 faces toward the vehicle body upper rear side, thereby enabling a portion of the collision load energy to be efficiently absorbed.

The suspension member 10 according to the present exemplary embodiment has been explained above based on the drawings. However, the suspension member 10 according to the present exemplary embodiment is not limited to that illustrated in the drawings, and the design may be changed as appropriate within a range not departing from the spirit of the present invention. For example, the sub side rail 18 is not limited to a configuration formed with a hat-shaped cross-section profile (formed with the ribs 28).

Moreover, the side rail 20 is not limited to a configuration including the sloped wall 26A, and the bent portion 22 of the side rail 20 is not limited to a configuration formed at substantially the length direction center portion of the side rail 20. Furthermore, the welding that line-joins the sub side rail 18 and the front body mount 14 to the respective side rail 20 is not limited to arc welding, and may be laser welding or the like.

As long as the configuration enables the side rail 20 to be suppressed or prevented from coming away from the sub side rail 18 and the front body mount 14 (fracturing of the arc welded portions is suppressed or prevented) when the side rail 20 has deformed so as to be bent from the bent portion 22, the arc welded (line-joined) locations of the lower end portions 18A of the sub side rail 18 and the lower end portions 14A of the front body mounts 14 do not need to be the intersecting-line portions NL of the outer wall 24 and the inner wall 26 of the side rail 20.

What is claimed is:

1. A suspension member, comprising:
a front cross member that is formed with a closed cross-section profile by extrusion forming a light metal, and that extends along a vehicle width direction;
a left and right pair of front body mounts that are each formed with an open cross-section profile open toward a vehicle body lower side by die-casting a light metal, and that are respectively joined to respective vehicle width direction end portions of the front cross member;
a rear cross member that is formed with an open cross-section profile open toward the vehicle body lower side by die-casting a light metal, that extends along the vehicle width direction, and that includes a left and right pair of sub side rails that integrally extend from respective vehicle width direction end portions of the rear cross member toward a vehicle body front side; and
a left and right pair of side rails that are formed with a closed cross-section profile by extrusion forming a light metal, that extend along an extension direction of the sub side rails, and that each include a bent portion protruding toward the vehicle body lower side at an extension direction intermediate portion of the side rail, wherein an end portion further toward the vehicle body front side than the bent portion is joined to the front body mount, an upper side of an end portion further toward a vehicle body rear side than the bent portion is covered by, and joined to, the sub side rail, and a lower side of the end portion further toward the vehicle body rear side than the bent portion is in an exposed state.

2. The suspension member of claim 1, wherein a lower end portion of the sub side rail is welded to an imaginary intersecting-line portion, which is an intersecting portion of a neutral plane of the side rail, in a case in which the side rail is deformed so as to be bent from the bent portion, and the wall portion of the side rail.

3. The suspension member of claim 1, wherein:
an upper side of the end portion of the side rail further toward the vehicle body front side than the bent portion is covered by, and joined to, the front body mount; and
a lower side of the end portion of the side rail further toward the vehicle body front side than the bent portion is in an exposed state.

4. The suspension member of claim 3, wherein a lower end portion of the front body mount is welded to an imaginary intersecting-line portion, which is an intersecting portion of a neutral plane of the side rail, in a case in which the side rail is deformed so as to be bent from the bent portion, and the wall portion of the side rail.

5. The suspension member of claim 1, wherein the sub side rail is formed with a hat-shaped cross-section profile.

6. The suspension member of claim 1, wherein the bent portion is formed at an extension direction center portion of the sub side rail.
